(19) United States
(12) Patent Application Publication
(10) Pub. No.: US 2026/0340094 A1
(43) Pub. Date: Oct. 29, 2026

(54) DISTANCE AS SECURITY FEATURE

(71) Applicant: TRINAMIX GMBH, Ludwigshafen am Rhein (DE)

(72) Inventors: Patrick SCHINDLER, Ludwigshafen am Rhein (DE); Ruben HUEHNERBEIN, Heidelberg (DE); Stephan KNAPP, Ludwigshafen am Rhein (DE); Maria KLODT, Ludwigshafen am Rhein (DE); Dimitri BUTOV, Ludwigshafen am Rhein (DE)

(21) Appl. No.: 19/115,389

(22) PCT Filed: Oct. 12, 2023
(86) PCT No.: PCT/EP2023/078381

§ 371 Date: Mar. 26, 2025

(30) Foreign Application Priority Data
Oct. 27, 2022 (EP) 22204117.0

(51) Int. Cl. G06F 21/32; G06F 21/62; G06V 10/74; G06V 40/60

(52) U.S. Cl. CPC G06F 21/32; G06F 21/6209; G06V 10/761; G06V 40/63

(57) ABSTRACT

Disclosed herein is a computer-implemented method for authorizing an object, the method including:
a) receiving at least one reflection image showing at least a part of the object while the object is illuminated at least partially with electromagnetic radiation,
b) determining a distance of the object from an image generation unit and/or from an illumination source based on the at least one reflection image,
c) determining if the distance is within or outside of a working range of an authentication process, and
   i) receiving a result from the authentication process of the object, and
      allowing the object to access a resource based on the result from the authentication process being positive and the distance being in the working range of the authentication process
or
   ii) declining the object to access a resource based on the distance being outside of the working range.

### TECHNICAL FIELD

The invention relates to a method for authorizing a user, use distance as obtained by method as described herein for allowing a user to access a resource and/or advice to a user, a computer program element with instructions, which when executed on a processing device is configured to carry out the steps of the method as described herein, a device for authorizing a user, a system for authorizing a user.

### TECHNICAL BACKGROUND

Authentication, e.g. of a face, is widely used, but is limited to certain range of application. For authentication, usually a visual representation of the object is generated and analyzed with a trained model such as a neural network. Such models usually have a limited operating range to ensure sufficient accuracy. Operating outside the ideal range leads to more erroneous classification, which can ultimately result in a security issue e.g. in the case of face recognition for access control. Hence, a solution is desired to improve functioning of authentication systems.

### SUMMARY

In an aspect, the disclosure relates to a computer-implemented method for authorizing an object, the method comprising:
a) receiving at least one reflection image showing at least a part of the object while the object is illuminated at least partially with electromagnetic radiation, and,
b) determining a distance of the object from an image generation unit and/or from an illumination source based on the at least one reflection image, and,
c) determining if the distance is within or outside of a working range of an authentication process, and,
   i) receiving a result from the authentication process of the object, and,
      allowing the object to access a resource based on the result from the authentication process being positive and the distance being in the working range of the authentication process.
OR
   ii) declining the object to access a resource based on the distance being outside of the working range.

In another aspect, it relates to a device and/or a system for authorizing an object, the system comprising:
a) a receiving unit for receiving at least one reflection image showing at least a part of the object while the object is illuminated with electromagnetic radiation, and/or receiving a result from the authentication process of an object,
b) a processor configured for determining at least one distance of the object from the device generating the reflection image and/or from the source of illumination based on the reflection image and determining if the distance is within or outside of a working range of an authentication process, and,
   i) allowing the object to access a resource based on the result from the authentication process being positive and the distance being in the working range of the authentication process.
OR
   ii) declining the object to access a resource based on the distance being outside of the working range.

In another aspect, it relates to a device and/or a system for authorizing an object, the system comprising:
a) a receiving unit for receiving at least one reflection image showing at least a part of the object while the object is illuminated with electromagnetic radiation, and/or receiving a result from the authentication process of an object,
b) a processor configured for determining if the distance is within or outside of a working range of an authentication process based on the at least one reflection image, and,
   i) allowing the object to access a resource based on the result from the authentication process being positive and the distance being in the working range of the authentication process.
OR
   ii) declining the object to access a resource based on the distance being outside of the working range.

In another aspect, it relates to use of the distance as obtained by the method as disclosed herein for allowing the object to access a resource and/or advice to an object associated with an authentication process.

In another aspect, it relates to a computer program element with instructions, which when executed on a processing device is configured to carry out the steps of the method as disclosed herein.

In another aspect, it relates to a non-transitory computer-readable data medium storing a computer program including instructions for executing steps of the method as described herein.

In another aspect, it relates to a method for authorizing an object, the method comprising:
a) receiving at least one reflection image showing at least a part of the object while the object is illuminated at least partially with electromagnetic radiation, and,
b) determining if the distance is within or outside of a working range of an authentication process based on the at least one reflection image, and,
   i) receiving a result from the authentication process of the object, and,
      allowing the object to access a resource based on the result from the authentication process being positive and the distance being in the working range of the authentication process.
OR
   ii) declining the object to access a resource based on the distance being outside of the working range.

The method and apparatus of the present disclosure allows for an easy, reliable, reproducible, repeatable, and secure authentication of an object. Furthermore, a fast possibility for checking prerequisites for reliable authentication is disclosed. Nowadays, authentication has to be fast and should require low hardware requirements since authentication such as face authentication is implemented widely. Face authentication for example is based on an image of the face of the object that is trying to access the device or system. Authentication processes require prerequisites such as a sufficient quality of an image for ensuring accuracy of the authentication process. In an authentication process involving an image of the object, the authentication process may be spoofed by an image representing at least a part of the authorized object in the desired image quality. Quality of images is determined by the hardware used and the use case itself. While performing authentication related to an image, the distance from the object to the device plays a distinct role when it comes to the quality of the image generated and for the quality of the underlying authentication process. Authentication processes have to fulfil requirements to obtain certification and be trustworthy to an object. Authentication processes have to be secure against spoofing. Spoofing utilizes weaknesses of authentication systems to gain access. In image-based authentication, a too large or too small distance may result in falsely allowing an unauthorized object to access a resource and hence, provide a significant security issue. Therefore, a working range may be specified as a measure for a range of distances where secure authentication process is possible. Thereby, determining a distance of the object from the device increases accuracy of authenticating an object while using standard equipment and the image received for authenticating. By doing so, further information is obtained from information received from the object. This is especially advantageous since time is saved, no further resources for generating information are needed and security of authentication is increased. Hence, disclosure describes a fast, secure and easy authentication.

### EMBODIMENTS

In the following, terminology as used herein and/or the technical field of the present disclosure will be outlined by ways of definitions and/or examples. Where examples are given, it is to be understood that the present disclosure is not limited to said examples.

In an embodiment, authorization may refer to a process for allowing an object to access a resource. Authorizing an object may comprise authenticating an object. In particular, an authenticated object may be allowed to access a resource. Authenticating may be a part of authorizing an object. Authentication may refer to proving a claim, preferably a claim of an object. Claim may be related to the identity of the object. Authentication may include biometric information, verified documents or the like. Biometric information may be information related to the appearance of the object. Biometric information may be associated with information related to finger, face, hand, iris, lips or the like. Verified documents may be documents verified by a governmental institution, an educational institution, an office of administration or the like. object may prove his/her identity by providing biometrical information. In some embodiment, authentication may be at least one of facial authentication, fingerprint authentication, authentication with iris.

In an embodiment, authentication process may include action performed for authenticating an object. Authentication process may include comparing an information related to the object initiating the authentication process with information related to an enrolled user. Enrolled user may be an authorized user. object may be authorized to access. Examples for information related to the object may comprise biometrical information or a password. Password may comprise numerical value, letter or graphical pattern. Authenticating may be image-based.

In an embodiment, determining a matching score may comprise determining an authentication result.

In an embodiment, object manager to arbitrary object. Object may include living organisms such as humans and animals. Object may be authenticated. In particular, object may be authenticated based on the at least one reflection image. Preferably, object may be a user.

In an embodiment, an authorized user may be a user allowed to access a resource.

In an embodiment, the method disclosed herein may further comprise and/or the authentication process may comprise of one or more of:
receiving an image of at least a part of the object,
generating a low-level representation of the image; and
determining a matching score of the low-level representation of the image and a low-level representation template,
providing an authentication result associated with the matching score. The image of at least the part of the object may be and/or may comprise biometric information. For example, the image may be an image of at least a part of a face of the object. Hence, biometric information may be associated with the part of the object, in particular a part of living organism.

In an embodiment, authentication result may indicate whether authentication of the object was successful. Authentication result may be positive if the object may be authenticated. Positive authentication result may refer to a matching score exceeding a threshold value. Authentication result may be negative if the object may not be authenticated, in particular if the object initiating the authentication process may be a person other than the enrolled users. Negative authentication result may refer to a matching score being equal or lower than a threshold value. Threshold value may be a predetermined value. Threshold value may be selected based on the required reliability needed for the authentication process. Authentication result may indicate whether the reflection image of the at least a part of the object can be matched with a template, in particular a template associated with an enrolled user. Authentication result may be a result of determining a matching score between a template and an image of an object, in particular the at least one reflection image with a template, in particular a template associated with an enrolled user.

In an embodiment, matching score may indicate the similarity between the low-level representation of the image and a low-level representation template. Low-level representation may comprise at least one feature vector. Feature vector may be indicative of a feature associated with the reflection image. Template vector may be indicative of a feature associated with the template, in particular a template of an enrolled user. Low-level representation template may comprise at least one template vector. Feature vector and/or template vector may comprise a n-dimensional vector. Vector may comprise at least one numerical value, preferably n numerical values. Matching score may indicate the distance between the feature vector and the template vector. In an example, a matching score may be obtained by determining the vector product of the feature vector and the template vector. Vector product may be a dot product.

In an embodiment, a working range may specify at least one upper and/or at least one lower boundary for a distance of an object from a camera and/or illumination source. Working range may be associated with an authentication process.

A working range may comprise at least one value. Value may be a numerical value, in particular a positive numerical value. An indication of a working range may be received, in particular prior to determining if the distance is within or outside of a working range of an authentication process. An indication of a working range may be suitable for determining if the distance is within or outside of a working range of an authentication process. An indication of a working range maybe suitable for comparing distance with a working range.

In an embodiment, reflection image as used herein may not be limited to an actual visual representation of an object. Instead, a reflection image comprises data generated based on electromagnetic radiation reflected by an object being illuminated by electromagnetic radiation. Reflection image may comprise at least one pattern. Reflection image may comprise at least one pattern feature. Reflection image may be comprised in a larger reflection image. A larger reflection image may be a reflection image comprising more pixels than the reflection image comprised in it. Dividing a reflection image into at least two parts may result in at least two reflection images. The at least two reflection images may comprise different data generated based on light reflected by an object being illuminated with light, e.g. one of the at least two reflection images may represent a living organisms nose and the other one of the at least two reflection images may represent a living organisms forehead. Reflection image may be suitable for determining a feature contrast for the at least one pattern feature. Reflection image may comprise a plurality of pixels. A plurality of pixels may comprise at least two pixels, preferably more than two pixels. For determining a feature contrast at least one pixel associated with the reflection feature and at least one pixel not associated with the reflection feature may be suitable. In particular, the term “reflection image” as used herein can refer to any data based on which an actual visual representation of the imaged object can be constructed. For instance, the data can correspond to an assignment of color or grayscale values to image positions, wherein each image position can correspond to a position in or on the imaged object. The reflection images or the data referred to herein can be two-dimensional, three-dimensional or four-dimensional, for instance, wherein a four-dimensional image is understood as a three-dimensional image evolving over time and, likewise, a two-dimensional image evolving over time might be regarded as a three-dimensional image. A reflection image can be considered a digital image if the data are digital data, wherein then the image positions may correspond to pixels or voxels of the image and/or image sensor. While generating the reflection image, the living organism may be illuminated with light, eventually being RGB light or preferably IR flood light and/or patterned light. Electromagnetic radiation may be patterned electromagnetic radiation. Patterned electromagnetic radiation may comprise at least one pattern. Patterned light may be projected onto the living organism. Patterned electromagnetic radiation may comprise patterned coherent electromagnetic radiation.

In an embodiment, a pattern may refer to an arbitrary known or pre-determined arrangement comprising at least one arbitrarily shaped pattern feature. The pattern may comprise at least one pattern feature. The pattern may comprise an arrangement of periodic or non-periodic pattern features. The pattern can be at least one of the following: at least one quasi random pattern; at least one Sobol pattern; at least one quasiperiodic pattern; at least one point pattern, in particular a pseudo-random point pattern; at least one line pattern; at least one stripe pattern; at least one checkerboard pattern; at least one triangular pattern; at least one rectangular pattern; at least one hexagonal pattern or a pattern comprising further convex tilings. A pattern may be an interference pattern produced by coherent electromagnetic radiation reflected from an object, e.g., reflected from an outer surface of that object or reflected from an inner surface of that object. A pattern typically occurs in diffuse reflections of coherent electromagnetic radiation such as laser light. Within the pattern, the spatial intensity of the coherent electromagnetic radiation may vary randomly due to interference of coherent wave fronts. A pattern feature is at least a part of a pattern. Pattern feature may comprise at least partially an arbitrarily shaped symbol. The symbols can be any one of: at least one point; at least one line; at least two lines such as parallel or crossing lines; at least one point and one line; at least one arrangement of periodic pattern features; at least one arbitrary shaped pattern.

In an embodiment, a distance of the object from an image generation unit and/or from an illumination source may be determined based on the at least one reflection image. Reflection image may comprise information associated with the distance. In the art a variety of methods are known for determining a distance based on an image, e.g. “depth from focus”, “depth from defocus” or triangulation. Distance may be determined by “depth from focus”, “depth from defocus” (DFD), triangulation, depth-from-photon-ratio (DPR) or combinations thereof. Different methods for determining a distance may provide different advantages depending on the use case as known in the art. Hence, combinations of at least two methods may provide more accurate results and thus, improve the reliability of an authentication process including distance determination. Distance obtained from at least two methods may comprise at least two distance values. At least two distance values may be combined by using at least one recursive filter and/or using a real function such as the arithmetic or geometric mean, a polynomial, preferably a polynomial up to the eights order in the at least two distance values.

In an embodiment, the method as described herein may further comprise determining a distance based on the at least one reflection by using one of more of depth from focus, depth from defocus, triangulation, depth-from-photon-ratio, determining a distance based on the distance between at least two spatial features based on a flood image and combinations thereof. Determining a distance of the object from an image generation unit and/or from an illumination source based on the reflection image may comprise one or more of the following techniques depth from focus, depth from defocus, triangulation, depth-from-photon-ratio, determining a distance based on measuring a distance between at least two spatial features in a flood image and combinations thereof. Spatial feature may be represented with a vector. Vector may comprise at least one numerical value. Example for spatial features of a face may comprise at least one of the following: the nose, the eyes, the eyebrows, the mouth, the ears, the chin, the forehead, wrinkles, irregularities such as scars, cheeks including cheekbones or the like. Other examples for spatial features may include finger, nails or the like.

In an embodiment, determining if the distance is within or outside of a working range of an authentication process based on the at least one reflection image may comprise determining a distance based on the at least one reflection by using one of more of depth from focus, depth from defocus, triangulation, depth-from-photon-ratio, determining a distance based on the distance between at least two spatial features based on a flood image and combinations thereof.

System and/or device may be configured for carrying out the steps of the method as described herein.

In an embodiment, determining a distance of the object from an image generation unit and/or from an illumination source based on the at least one reflection image may comprise one or more of depth-from-photon-ratio, triangulation, determining a distance based on the distance between at least two spatial features based on a flood image and combinations thereof.

In an embodiment, determining a distance of the object from an image generation unit and/or from an illumination source based on the at least one reflection image may be based on measuring the distance between at least two spatial features in a flood image and comparing the distance between at least two spatial features in a flood image with a reference. Distance between at least two spatial features associated with the object may be indicative of a distance of the object and an illumination source and/or an image generation unit. Distance between at least two spatial features associated with the object may be related to a distance of the object and an illumination source and/or an image generation unit. Distance of the object from an illumination source and/or an image generation unit may be determined based on a relation of the distance between at least two spatial features associated with the object in a flood image and the distance of the object from an illumination source and/or an image generation unit. Determining a distance of the object from an illumination source and/or an image generation unit may be determined based on a reference. Reference may include a distance between at least two spatial features associated with the object and a distance of the object from an illumination source and/or an image generation unit. Hence, determining a distance of the object from an illumination source and/or an image generation unit may comprise referencing the distance between at least two spatial values associated with the object in a flood image to a predetermined distance between at least two spatial values associated with an object. For example, the distance between a human's eyes may be about 5 cm at a distance of 1 m from the camera and the distance between a human's eyes in a flood image may be 1 cm. Based on this information, the distance of the human from the camera may be determined. Relation between distance of the object from an illumination source and/or an image generation unit and distance between at least two spatial features associated with the object may be obtained by using equations of optics or by interpolating between several distance values.

In an embodiment, a distance of the object from an image generation unit and/or from an illumination source may be determined based on the at least one reflection image by using a model.

In an embodiment, the method as disclosed herein may further comprise determining a distance based on the at least one reflection image by using a model.

In an embodiment, a distance of the object from an image generation unit and/or from an illumination source may be determined based on determining the distance between at least two spatial features in a flood image. Model may be trained with a training data set comprising at least one flood image and a distance associated with the object shown at least partially in the flood image. In an embodiment, model may implement the relation of the distance between at least two spatial features associated with the object in a flood image and the distance of the object from an illumination source and/or an image generation unit.

In an embodiment, determining a distance may refer to measuring a distance.

It is remarked that the order of the method steps is not fixed to the order given in the text and may be changed.

In an embodiment, determining if the distance is within or outside of a working range of an authentication process based on the at least one reflection image may comprise determining a distance of the object from an image generation unit and/or from an illumination source based on the at least one reflection image, and/or, determining if the distance is within or outside of a working range of an authentication process.

In an embodiment, distance may be determined by depth from defocus. Depth from defocus may comprise optimizing at least one blurring function fₐ. Blurring function fₐ may refer to as blur kernel or point spread function, refers to a response function of a detector to the illumination from the object. Specifically, the blurring function may model the blur of a defocused object. The at least one blurring function fₐ may be a function or composite function composed from at least one function from the group consisting of: a Gaussian, a sinc function, a pillbox function, a square function, a Lorentzian function, a radial function, a polynomial, a Hermite polynomial, a Zernike polynomial, a Legendre polynomial. Distance may be referred to as longitudinal coordinate z. The longitudinal coordinate z_{DFD} may be determined by using at least one convolution-based algorithm such as a depth-from-defocus algorithm. To obtain the distance from the image, the depth-from-defocus algorithm estimates the defocus of the object. A longitudinal coordinate z_{DFD} may be determined by optimizing the at least one blurring function fₐ. The blurring function may be optimized by varying the parameters of the at least one blurring function. The image may be a blurred image is, in particular a blurred reflection image. A longitudinal coordinate z may be reconstructed from the blurred image is and the blurring function fₐ. The longitudinal coordinate z_{DFD} may be determined by minimizing a difference between the blurred image i_{b} and the convolution of the blurring function fₐ with at least one further image i′_{b},

$$min ‖ ( {i}_{b}^{′} * {f}_{a} ( σ ( z ) ) - {i}_{b} ) ‖ ,$$

by varying the parameters σ of the blurring function. σ(z) is a set of distance dependent blurring parameters. The further image may be blurred or sharp. As used herein, the term “sharp” or “sharp image” refers to a blurred image having a maximum contrast. The at least one further image may be generated from the blurred image is by a convolution with a known blurring function. Thus, the depth-from-defocus algorithm may be used to obtain the longitudinal coordinate z_{DFD}.

In an embodiment, distance may be determined by depth-from-photon-ratio. Depth from photon ratio may be based on a combination of a measure for intensity associated with the first location in an image and a second measure for intensity associated with a second location. DPR may be based on a quotient of a measure for an intensity associated with a first location in an image and a second measure for an intensity associated with a second location. Preferably, first location may be a location other than the second location. Measure for an intensity may comprise but are not limited to an intensity, an absorbance, an extinction, a relative intensity, e.g. by relating the final intensity to the initial intensity or the like. Quotient of at least one first measure for an intensity associated with a first location in an image and at least one second measure for an intensity associated with a second location may be related to the distance. Quotient of a first measure for an intensity associated with a first location in an image and a second measure for an intensity associated with a second location may be suitable for determining a distance. Distance may be in at least one measurement range independent from the object size in an object plane. Quotient of a measure for an intensity associated with a first location in an image and another measure for an intensity associated with a second location comprises one or more of: dividing at least the first measure and/or at least then second measure, dividing multiples of at least the first measure and/or at least the second measure, dividing linear combinations of at least the first measure and/or at least the second measure. Electromagnetic radiation used for illumination may be associated with at least one beam profile. Measure for an intensity may further comprise at least one information related to at least one beam profile of the light beam associated with the electromagnetic radiation. Beam profile may be one of a trapezoid beam profile; a triangle beam profile; a conical beam profile and a linear combination of Gaussian beam profiles. Furthermore, first measure for an intensity may comprise information of a first area of the beam profile and a second measure for an intensity may comprise information of a second area of the beam profile. First area of the beam profile the second area of the beam profile may be adjacent or overlapping areas. Measure for intensity may be obtained by integrating the intensities of an area in the least one reflection image. First measure for intensity associated with the first location in an image may be obtained by integrating the intensities of the at least one area associated with the first location in the at least one reflection image. Second measure for intensity associated with the second location in an image may be obtained by integrating the intensities of the at least one area associated with the second location in the at least one reflection image.

In an embodiment, determining the distance may be associated with determining the first area of the beam profile and the second area of the beam profile. First area of the beam profile may comprise essentially edge information of the beam profile and the second area of the beam profile may comprise essentially center information of the beam profile. Edge information may comprise an information relating to a number of photons in the first area of the beam profile and the center information may comprise an information relating to a number of photons in the second area of the beam profile. Determining the distance based on the quotient may comprise dividing the edge information and the center information, dividing multiples of the edge information and the center information, dividing linear combinations of the edge information and the center information. Quotient Q may be expressed as

$$\begin{matrix}{\int \int }_{{A}_{1}} E ( x , y ; {z}_{O} ) dxdy \\ Q ( {z}_{O} ) = \overline{{\int \int }_{{A}_{2}} E ( x , y , {z}_{o} ) d x d y}\end{matrix}$$

wherein x and y are transversal coordinates in the image, A1 and A2 are areas of the beam profile, and E (x,y,zₒ) denotes the beam profile given at the object distance zₒ. Other embodiments are disclosed in EP17797964A 2017 Nov. 17, which is included by reference herewith.

In an embodiment, distance may be determined by triangulation. Triangulation may be based on trigonometrical equations. Trigonometrical equations may be used for determining a distance. Triangulation may be based on the at least one reflection image and a baseline. Baseline may refer to distance between the illumination source and the image generation unit. Baseline may be received. In particular, baseline may be received together with the at least one reflection image.

In an embodiment, distance may be determined based on a combination of depth from photon ratio and triangulation.

In an embodiment, distance may be determined based on a combination of depth from photon ratio triangulation and depth from defocus.

In an embodiment, a distance may be determined based on a combination of DPR and DFD. For this purpose, distance is determined by DPR and DFD and the at least two distance values may be combined.

In an embodiment illumination may be achieved by using a projector or illumination source which emits the light pattern onto the part of the living organism. The illumination source may comprise at least one light source. The illumination source may comprise a plurality of light sources. The illumination source is suitable for illuminating an object. The illumination source may comprise an artificial illumination source, in particular at least one laser source and/or at least one incandescent lamp and/or at least one semiconductor light source, for example, at least one light-emitting diode, in particular an organic and/or inorganic light-emitting diode. As an example, the light emitted by the illumination source may have a wavelength of 300 to 1100 nm, especially 500 to 1100 nm. Additionally or alternatively, light in the infrared spectral range may be used, such as in the range of 780 nm to 3.0 μm. Specifically, the light in the part of the near infrared region where silicon photodiodes are applicable specifically in the range of 700 nm to 1100 nm may be used. Using light in the near infrared region allows that light is not or only weakly detected by human eyes and is still detectable by silicon sensors, in particular standard silicon sensors. The illumination source may be adapted to emit light at a single wavelength. In other embodiments, the illumination may be adapted to emit light with a plurality of wavelengths allowing additional measurements in other wavelengths channels. The light source may be or may comprise at least one multiple beam light source. For example, the light source may comprise at least one laser source and one or more diffractive optical elements (DOEs). The illumination source may comprise at least one line laser. The line laser may be adapted to send a laser line to the object, for example a horizontal or vertical laser line. The illumination source may comprise a plurality of line lasers. For example, the illumination source may comprise at least two line lasers which may be arranged such that the illumination pattern comprises at least two parallel or crossing lines. The illumination source may comprise the at least one light projector adapted to generate a cloud of points such that the illumination pattern may comprise a plurality of point pattern. The illumination source may comprise at least one mask adapted to generate the illumination pattern from at least one light beam generated by the illumination source.

In an embodiment, processor may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor based processor, a quantum processor, or any other type of processor configures for processing instructions. As an example, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

In an embodiment, receiving unit may comprise of one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices.

In an embodiment, allowing the object to access a resource may include allowing the object to perform at least one operation with a device and/or system. Resource may be a device, a system, a function of a device, a function of a system and/or an entity. Additionally and/or alternatively, allowing the object to access a resource may include allowing the object to access an entity. Entity may be physical entity and/or virtual entity. Virtual entity may be a database for example. Physical entity may be an area with restricted access. Area with restricted access may be one of the following: security areas, rooms, apartments, vehicles, parts of the before mentioned examples, or the like. Device and/or system may be locked. Device and/or system may only be unlocked by authorized user. Device and/or system may be suitable for comparing an information related to the object initiating the authentication process with information related to an authorized user. Information related to an authorized user may be generated during an enrollment process. User undergoing an enrollment process may be referred to as enrolled user. Information related to the authorized user generated in an enrollment process may be stored in a memory of the device and/or system. Information related to the authorized user may include a low-level representation template. Low-level representation template may be stored in a memory. Device and/or system may be suitable for performing at least one action.

In an embodiment memory may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

In an embodiment a wireless communication protocol may be used. The wireless communication protocol may comprise any known network technology such as GSM, GPRS, EDGE, UMTS/HSPA, LTE technologies using standards like 2G, 3G, 4G or 5G, The wireless communication protocol may further comprise a wireless local area network (WLAN), e.g. Wireless Fidelity (Wi-Fi).

In an embodiment, image generation unit may be suitable for generating at least one image, in particular a reflection image. Image generation unit may comprise a camera. Camera specifically may refer, without limitation, to a device having at least one imaging element configured for recording or recording spatially resolved one-dimensional, two-dimensional or even three-dimensional optical data or information. The camera may be a digital camera. As an example, the camera may comprise at least one camera chip, such as at least one CCD chip and/or at least one CMOS chip configured for recording images. The camera may be or may comprise at least one near infrared camera and/or an RGB camera. Furthermore, the camera, besides the at least one camera chip or imaging chip, may comprise further elements, such as one or more optical elements, e.g. one or more lenses.

In an embodiment, device and/or system may be suitable for carrying out the steps of the methods as described herein. Device may be a non-stationary device or may be integrated into a non-stationary device. The term “non-stationary device” specifically may refer, without limitation, to a mobile electronic device, more specifically to a mobile communication device such as a cell phone, smartphone or smartwatch. Additionally or alternatively, the mobile device may also refer to a laptop, a tablet or another type of portable computer. In some embodiments, device may be a server, a database, a cloud computing environment or the like. In other embodiments, the first device may be integrated in a stationary device and/or may be a stationary device. Such a stationary device may be non-movable by human like entries e.g. with gates, pillars or similar access limiting objects, POA, building, vehicle, B-pillars or the like. System may comprise of at least two devices. Device and/or system may comprise an image generation unit and/or an illumination source.

In an embodiment, computer-readable data medium may refer to any suitable data storage device or computer readable memory on which is stored one or more sets of instructions (for example software) embodying any one or more of the methodologies or functions described herein. The instructions may also reside, completely or at least partially, within the main memory and/or within the processor during execution thereof by the computer, main memory, and processing device, which may constitute computer-readable storage media. The instructions may further be transmitted or received over a network via a network interface device. Computer-readable data medium include hard drives, for example on a server, USB storage device, CD, DVD or Blue-ray discs. The computer program may contain all functionalities and data required for execution of the method according to the present disclosure or it may provide interfaces to have parts of the method processed on remote systems, for example on a cloud system. The term non-transitory may have the meaning that the purpose of the data storage medium is to store the computer program permanently, in particular without requiring permanent power supply.

These and other objects, which become apparent upon reading the following description, are solved by the subject matters of the independent claims. The dependent claims refer to embodiments of the invention.

The steps of the method can be carried out in different order. Order is not limited by the sequence of steps of the method.

In an embodiment, distance of an object from an illumination source and/or an image generation unit may be determined in an enrolment process of a user. Enrolment process may be suitable for generating a template. Template may be a low-level representation template. Template may be stored after generation by a device. Enrolment process may be performed before an authentication may be performed. Enrolment process may be a preceding process to at least one authentication process. Enrolment process may be performed at least once per user. Enrolment process faces the same problem as an authentication process. Enrolment process generates template used for authentication later and the template determines how accurately and precisely an object will be authenticated. Hence, a fast, reliable and reproducible enrolment process is of key importance. Determining the distance of an object from the illumination source and/or image generation unit provides an easy way for ensuring that the quality of the template matches the requirements for a template. In addition, the working range of an authentication process applies to an enrolment process as well.

An exemplary enrolment process may comprise of:
providing and/or generating a template image of a at least a part of an object, e.g., a fingerprint feature or a facial feature;
generating a low-level representation template from the template image; and
storing the low-level representation template.

The low-level representation template may be associated with a lower dimension than the template image. The low-level representation template may be obtained by reducing the dimensionality of the template image. Hence, generating the low-level representation template from the template image may comprise providing the template image to an encoder configured for receiving images, in particular template images and reducing the dimensionality of the received images, in particular template images. Reducing the dimensionality of the received images, in particular template images may refer to generating the low-level representation template from the template image.

In an embodiment, a low-level representation of the image may be associated with a lower dimension than the image. The low-level representation image may be obtained by reducing the dimensionality of the image. Hence, generating the low-level representation image from the image may comprise providing the image to an encoder configured for receiving images and reducing the dimensionality of the received images. Reducing the dimensionality of the received images, may refer to generating the low-level representation image from the image.

In an embodiment, a part of a system and/or device may be connected via a wired and/or wireless connection. Examples for a wireless connection may implement a wireless communication protocol.

In an embodiment, determining if the distance is within or outside of a working range of an authentication process may comprise determining a distance based on the at least one reflection image and/or comparing the distance with a working range. Determining if the distance is within or outside of a working range of an authentication process may comprise determining whether the distance may be comprised in the working range. Working range may specify at least two boundaries.

In an embodiment, a model may be used for determining a distance. Preferably, the model may be according to a training data set. More preferably, the model may be trained according to a training data set. Use of training data allows to customize the method to details of the concrete installation without the need to determine the setup in detail.

In an embodiment, identifying may comprise authenticating.

In an embodiment, determining a distance of the object from an image generation unit and/or from an illumination source based on the at least one reflection image may refer to measuring a distance of the object from an image generation unit and/or from an illumination source based on the at least one reflection image.

In an embodiment, distance may be determined by using a model.

In an embodiment, determining a distance based on the reflection image may comprise one of more of depth from focus, depth from defocus, triangulation, depth-from-photon-ratio and combinations thereof.

In an embodiment, model is suitable for determining an output based on an input. A model may be a mechanistic model, a data-driven model or a hybrid model. The mechanistic model, preferably, reflects physical phenomena in mathematical form, e.g., including first-principle models. A mechanistic model may comprise a set of equations that describes an interaction between the object and the electromagnetic radiation.

Preferably, the data-driven model may be a classification model. The classification model may comprise at least one machine-learning architecture and model parameters. For example, the machine-learning architecture may be or may comprise one or more of: linear regression, logistic regression, random forest, piecewise linear, nonlinear classifiers, support vector machines, naive Bayes classifications, nearest neighbours, neural networks, convolutional neural networks, generative adversarial networks, support vector machines, or gradient boosting algorithms or the like. In the case of a neural network, the model can be a multi-scale neural network or a recurrent neural network (RNN) such as, but not limited to, a gated recurrent unit (GRU) recurrent neural network or a long short-term memory (LSTM) recurrent neural network. If the model may be a classification model, determining a distance of the object from an image generation unit and/or from an illumination source based on the at least one reflection image, and, determining if the distance is within or outside of a working range of an authentication process may refer to determining if the distance is within or outside of a working range of an authentication process based on the at least one reflection image. Classification model may be trained based on training data set comprising at least one reflection image and an indication if the distance of the object associated with the at least one reflection image is within or outside of a working range.

The data-driven model may be trained based on training data. The term “training”, also denoted learning, as used herein, is a broad term and is to be given its ordinary and customary meaning to a person skilled in the art and is not to be limited to a special or customized meaning. Training may also include parametrizing. The term specifically may refer, without limitation, to a process of building the model, in particular determining and/or updating parameters of the model. Updating parameters of the classification model may also be referred to as retraining. Retraining may be included when referring to training herein. The classification model may be at least partially data-driven. The classification model may be trained based on training data. Training data may comprise at least one reflection image and at least one distance, preferably the distance may be associated with the reflection image. Training the data-driven model may comprise providing training data to the model. The training data may comprise at least one training dataset. During the training the data-driven model may adjust to achieve best fit with the training data, e.g. relating the at least on input value with best fit to the at least one desired output value. For example, if the neural network is a feedforward neural network such as a CNN, a backpropagation-algorithm may be applied for training the neural network. In case of a RNN, a gradient descent algorithm or a backpropagation-through-time algorithm may be employed for training purposes.

In an embodiment, a training data set may comprise at least one input and at least one desired output. A training data set may comprise of at least one reflection image and a distance, in particular a distance associated with the at least one reflection image. In particular, a training data set may comprise of a plurality of reflection images and a plurality of distances.

Training a model may include or may refer without limitation to calibrating the model. The model may be suitable for measuring a desired value such as a target value and/or a reference value. The model may be referred to as a measuring system, e.g. for measuring a target value and/or a reference value.

In an embodiment, authentication process may use a model.

In an embodiment, the methods as described herein and/or the authentication process may be carried out by a mobile device.

In an embodiment, the authentication process may be based on biometric information. Biometric information may be information readily available from an authorized user. Further, biometric information is advantageous since a user may not forget it. Restoring passwords in comparison to using biometric information automatically carried by the user is prone to errors and security issues. Ultimately, biometric information is considered to be unique, because the body is based on a unique genome.

In an embodiment, declining an object to access a resource may be based on the distance being outside of the working range of the authentication process and/or the authentication result being negative.

In an embodiment, the object may be provided with feedback based on determining if the distance is within or outside of a working range of an authentication process. Feedback may comprise of user-related information and/or process-related information. A user-related information may comprise of information selected for the user involved in the process. According to an embodiment, the user-related information includes:
a user guidance for navigating the user through the process,
a required user action,
a specific information for the user based on a current status of the user, in particular requesting inputting authentication information by the user and/or
a user representation.

User guidance for navigating the user through the process may comprise instructions. Instructions may be associated with explanations. Explanations may be suitable for explaining the process to the user. Examples may be advising the user to change the distance between him or her and the device. A required user action can be an action that the user has to perform in order for the process to continue. Examples may be selecting an option out of several, entering additional information such as authentication information, or the like. A user representation may be suitable for representing the user's physical appearance. Examples may be a representation of the user's face in a face authentication process.

For example, an increased transparency for the user during the execution of the process, e.g. a face authentication process, is achieved by representing the user (e.g. during illumination) wherein the representation can be an image of the user recorded with a RGB or IR camera, an Animoji (animated emoji) generated from image data obtained with the active illumination source illuminating light and the camera generating at least one image. Furthermore, advantages of a user representation are besides increasing the transparency for the user, other error sources can be recognized, like grease or dirt on the display.

A process-related information comprises information selected for the execution of the process. According to an embodiment, the process-related information includes:
information associated with a type of the process,
upcoming events related to the process, and/or
highlighting parts of the display device involved into the process.

Information associated with the type of process refers to a name or a symbolic representation of the process. Exemplary names for processes can be authentication process, payment process, or the like. Upcoming events related to the process may be subsequent processes or termination of the process or an application after the process is completed. Parts of the display device may be highlighted with symbols, representation or text referring to a part of the display device. In an exemplary scenario, the camera may be highlighted by means of text, a camera symbol close to or above the camera. In other scenarios, a fingerprint sensor may be highlighted by representing a fingerprint in the area where the finger of the user needs to be placed.

In an embodiment, at least a part of the methods as described herein may be repeated in response to the distance being outside of the working range on the authentication process. Steps to be repeated may include at least one of: receiving at least one reflection image showing at least a part of the object while the object is illuminated at least partially with electromagnetic radiation, determining a distance of the object from an image generation unit and/or from an illumination source based on the at least one reflection image or determining if the distance is within or outside of a working range of an authentication process. Feedback may be advantageous since the user may adjust according to the feedback received and the process may be repeated. By doing so, the user experience is increased and the process has an increased efficiency. If a distance may be outside of the working range, user may desire to authenticate again. Hence, a workflow can be implemented to restart the authentication including determining the distance. This saves time and in the context of battery-powered devices saves energy.

In an embodiment, the distance may be determined being within or outside the working range of the authentication process prior to providing the result of the authentication process, in particular based on the at least one reflection image.

In an embodiment, the at least one reflection image may be received and/or generated in response to receiving an unlock request initiated by the object.

In an embodiment, more than one distance may be determined for more than one location in the reflection image and the object may be allowed to access a resource based on the more than one distance being in the working range. This may be advantageous to increase the accuracy of authenticating an object even more since a part of the object may be in the working range, wherein another part may not be in the working range. Therefore, more than one value for the distance may be determined in order to ensure better functioning.

In an embodiment, the electromagnetic radiation may comprise patterned electromagnetic radiation and/or may be in the infrared range.

### BRIEF DESCRIPTION OF THE DRAWINGS

In the following, the present disclosure is further described with reference to the enclosed figures. The same reference numbers in the drawings and this disclosure are intended to refer to the same or like elements, components, and/or parts.

FIGS. 1a and 1b illustrate an example embodiment of a device 101 and a system 102 for authorizing an object.

FIG. 2 illustrates an example embodiment of a method for authorizing an object 200.

FIG. 3 illustrates an example embodiment of authentication an object.

FIG. 4 illustrates an example embodiment of a method for authorizing an object 400

### DETAILED DESCRIPTION

The following embodiments are mere examples for implementing the method, the system or application device disclosed herein and shall not be considered limiting.

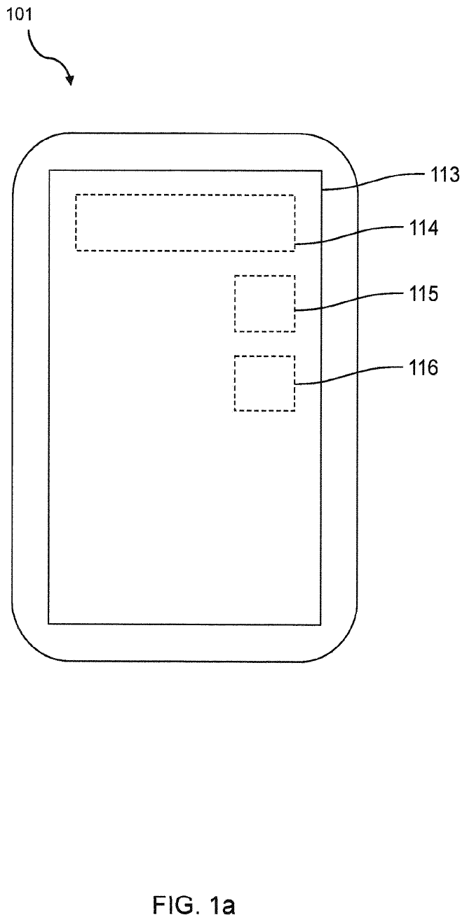

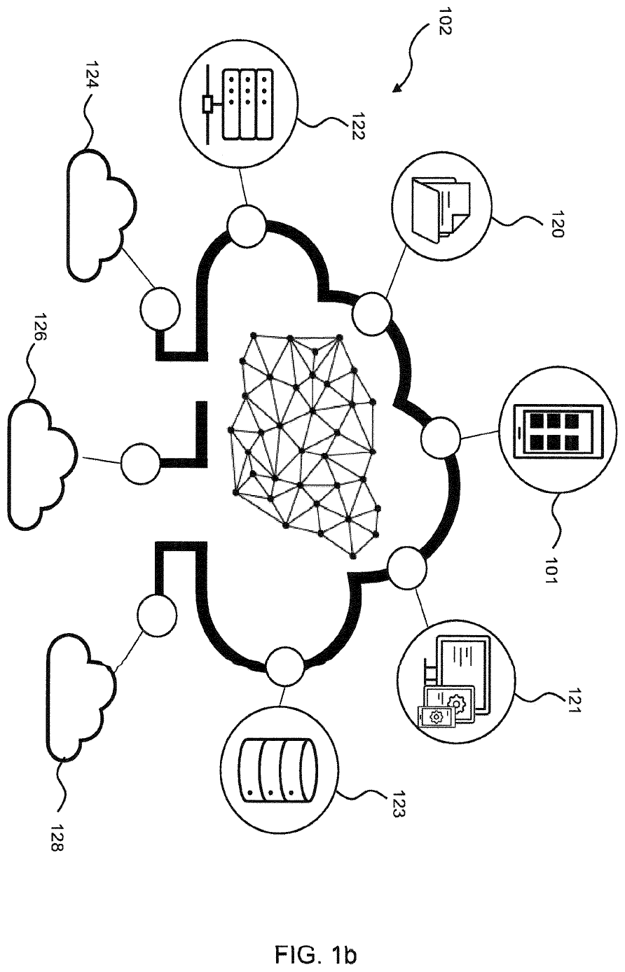

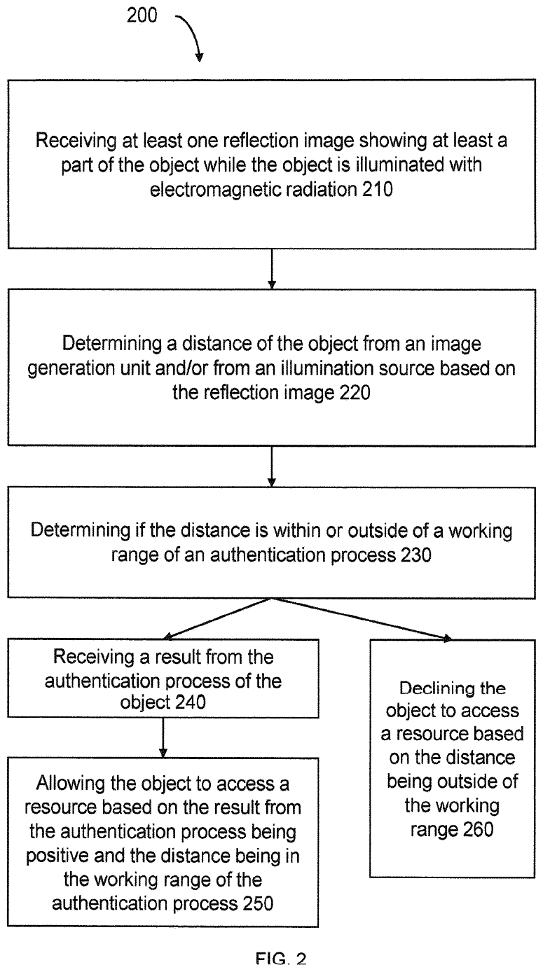

FIG. 1a illustrates an example embodiment of a device 101 for authorizing an object. Device may be a mobile device, e.g. smartphone, laptop, smartwatch, tablet or the like, and/or a nonmobile device, e.g. desktop computer, server, authentication point such as a gate or the like. Device may be suitable for performing the actions and/or methods as described in FIG. 2-4 Device may be a user device. Device comprises a receiving unit 116 and a processor 114. Device may further include an image generation unit 115 and/or a display 113. Receiving unit 116 may receive at least one reflection image from the image generation unit 115. Processor 114 may be provided with at least one image via the receiving unit 116. Receiving 116 unit may use a wireless communication protocol. Processor 114 may be suitable for allowing an object to access. Display 113 may be used for providing information to the object. Display may comprise a graphical user interface. Display 113 may be suitable for initiating an authentication process. In response to initiating an authentication process, receiving unit 116 may receive an unlock request. In response to the unlock request, a distance of the object from the device may be determined and an authentication process may be initiated. Authentication process may be carried out by the processor 114. Processor 114 may determine a result from an authentication process and/or may determining if the distance is within or outside of a working range of an authentication process. Based on the result from the authentication process and determination if the distance is within or outside of a working range of an authentication process, processor 114 may be suitable for allowing an object to access a resource. Processor 114 may allow an object to access a resource by performing at least one action. Action may be requested by the object. Object may have requested the action via the graphical user interface. Object may have initiated the authentication process by requesting the at least one action.

Display 113 may display an access grant, an access denial, feedback and/or the like. Display 113 may be used to inform the object of the authentication and/or enrolment process. Device 101 may be a display device. Imaging unit may be suitable for generating an image, in particular a reflection image showing at least a part of the object while the object is illuminated with electromagnetic radiation. Processor 114 may be connected to the receiving unit 116.

FIG. 1b illustrates an example embodiment of a system for authorizing an object 102. System 102 may be an alternative to a device 101 as described in FIG. 1a. System 102 may comprise components of the device 101 as described in FIG. 1a. Components of device 101 may be distributed along the computing resources of the system.

System 102 may be a distributed computing environment. In this example, the distributed cloud computing environment may contain the following computing resources: device(s) 101, data storage 120, applications 121, server(s) 122, and databases 123. The cloud computing environment 102 may be deployed as public cloud 124, private cloud 126 or hybrid cloud 128. A private cloud 124 may be owned by an organization and only the members of the organization with proper access can use the private cloud 126, rendering the data in the private cloud at least confidential. In contrast, data stored in a public cloud 126 may be open to anyone over the internet. The hybrid cloud 128 may be a combination of both private and public clouds 124, 126 and may allow to keep some of the data confidential while other data may be publicly available. Components of the distributed computing environment may carry out at least one step of the methods as described herein. In a non-limiting example, device 101 may generate an image. Alternatively or additionally, reflection image may be received from a database 123 and/or a data storage 120 and/or a cloud 124-128 by a processor configured for carrying out the steps of the method. Processor may be or may be comprised by a server 122 or a cloud 124-128. Applications 121 may include instructions for carrying out the steps of the method as described in the context of FIGS. 2 to 4.

FIG. 2 illustrates an example embodiment of a method for authorizing an object 200. Method may be carried out by a device and/or system as described in the context of FIG. 1. At least one reflection image showing at least a part of the object while the object is illuminated with electromagnetic radiation is received. Object may be illuminated by an illumination source and/or the at least one reflection image may be generated by an image generation unit. Reflection image may be preprocessed before being received. Preprocessing may include performing at least one of image augmentation techniques. Image augmentation techniques may refer to scaling, cutting, rotating, blurring, warping, shearing, resize, folding, changing the contrast, changing the brightness or the like. Advanced Graphics Programming Using OpenGL-A volume in The Morgan Kaufmann Series in Computer Graphics by TOM McREYNOLDS and DAVID BLYTHE (2005) ISBN 9781558606593, https://doi.org/10.1016/B978-1-55860-659-3.50030-5 for a non-exhaustive list of image augmentation techniques. Preprocessing may include identifying at least a part of the reflection image referring to the object. Preprocessing may further include changing and/or removing data independent of the object. Additionally, preprocessing may include generating at least two partial images from at least one image. Reflection image may be a partial image.

At least one distance of the object from an image generation unit and/or from an illumination source is determined based on the reflection image 220. Image generation unit and/or illumination source may be part of a device or a system. Hence, a distance between the object and the device or system may be determined. Distance may comprise a numerical value. Distance may be comparable to the working range.

The distance is determined to be within or outside of a working range of an authentication process. Authentication process may specify a working range. Working range may comprise at least two values. Working range may be process specific. Working range may be chosen to obtain sufficient results for the authentication process. Numerical values associated with working range and numerical value associated with distance may be compared. Distance may comprise a numerical value within or outside the range determined by the at least two values associated with the working range. A distance may be within a working range if the numerical values associated with the distance are equal to the at least two numerical values associated with the working range or smaller than at least one of the at least two numerical values associated with the working range or greater than at least one of the at least two numerical values associated with the working range. Result of determining if the distance is within or outside of a working range of an authentication process may comprise a Boolean value. Distance may be within the working range resulting in a positive Boolean value. Distance may be outside of the working range resulting in a negative Boolean value.

An authentication process may be conducted parallel to determining a distance or prior to determining a distance or after having determined a distance. Authentication process may be a face authentication process, a fingerprint authentication process, a process including the iris of a user's eye or the like. For this purpose, respective information may be received from the object. Preferably, an image associated with information relating to the object may be received and compared to a template. Based on the comparison of received information and the template a match or a mismatch may be obtained. Matching the template with information related to the object may result in a positive authentication result. Mismatching the template with information related to the object may result in a negative authentication result. Result of authentication process may be provided. Positive result may refer to authenticating the object. Negative result may refer to not authenticating the object. Not authenticating the object may refer to the object not being authorized, e.g. for unlocking and/or using the device, having access to a system, receiving an information, in particular personal or confidential information. A result from the authentication process of the object is received 240. Result from the authentication process may be received. Object may be allowed to access a resource based on the result from the authentication process.

An object is allowed to access a resource based on the result from the authentication process being positive and the distance being in the working range of the authentication process 250. A distance within the working range and a positive result from an authentication process may result in allowing the object to access. A distance outside the working range may result in declining the object to access a resource. Object may be allowed to access a resource such as a function of a device and/or system. An example for a function of a device and/or system may be initiating an action of the device and/or system. object may be allowed to access a personal and/or confidential information. In an example, device may be unlocked after authorizing the object as described herein. In another example, object may request access to a functionality of the device such as initiating an application on the device or object may be provided with data stored on the device or data to be retrieved with the device. In yet another example, object may try to access information of a cloud system and object may be authenticated beforehand.

Alternatively to steps 240 and 250, the object may be declined to access a resource based on the distance being outside of the working range 260. Declining the object may result in another authentication process. Declined object may be a spoofing object such as a mask. Declining an object may be independent of the result of the authentication process. Declining an object may be based on the result of the authentication process and/or the determined distance outside of the working range. An authentication process may not be started based on the distance being outside of the working range. By doing so, time and resources are saved since the process is steered more efficiently.

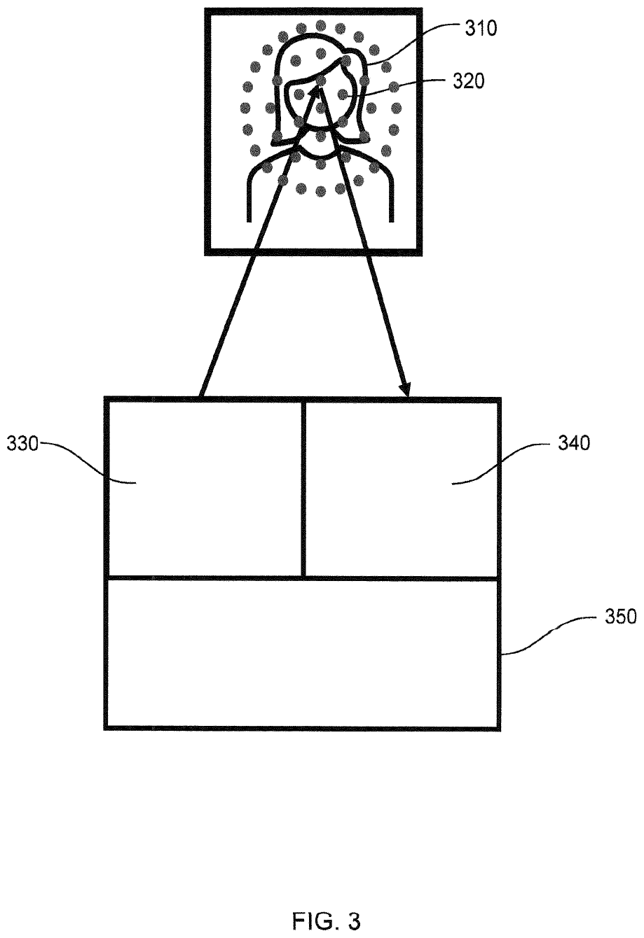

FIG. 3 illustrates an example embodiment of authentication an object 310. object 310 may be illuminated with electromagnetic radiation, preferably patterned electromagnetic radiation. In some embodiments, patterned electromagnetic radiation may comprise a pattern with a pattern feature 320 such as a dot. Pattern may be projected onto the object. Electromagnetic radiation may be emitted by an illumination source 330. Electromagnetic radiation may be reflected from the object, in particular the skin of the object. Reflection image may be generated based on the reflected electromagnetic radiation received by the image generation unit 340. Image generation unit 340 may generated an image, in particular a reflection image. Image generation unit 340 and illumination source may be part of a device 350 as described in the context of FIG. 1. Device may perform authentication and/or distance determination based on the generated image. 350 may be another example embodiment of a system for authentication an object.

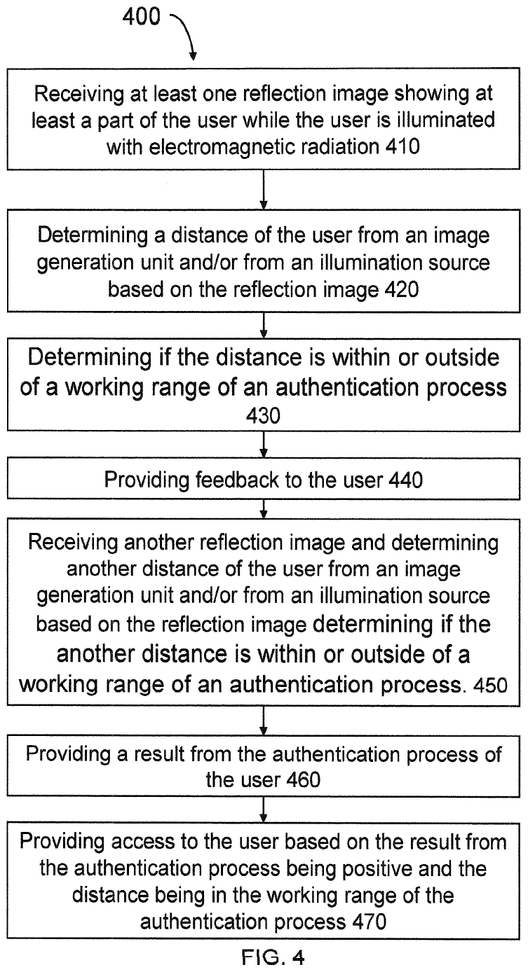

FIG. 4 illustrates an example embodiment of a method for authorizing an object 400. At least one reflection image is received as described in the context of FIG. 2. A distance of the object from an image generation unit and/or from an illumination source based on the reflection image is received as described in the context of FIG. 2 420. The distance is to be within or outside of a working range of an authentication process 430 as described in the context of FIG. 2. Feedback may be provided to the object 440 based on the distance being within or outside of the working range. Distance may be outside of the working range of the authentication process. In response to the distance being outside of the working range, repeating the steps of receiving at least one reflection image, determining a distance and determining if the distance is within or outside of a working range of an authentication process may be triggered. object may be informed about the process. object may be provided with feedback 440. Feedback provided to the object may include that the process may be repeated and/or that the distance was outside of the working range. In some embodiments, the object may be provided with information if the distance was greater than the upper boundary of the working range or the object may be provided with information if the distance was smaller than the upper boundary of the working range. Based on the information relating the distance to the working range, the object may be provided with advice. Advice may be for example, “move closer to the camera” or “increase the distance between the device and you”. By providing feedback to the object, the object is informed about the ongoing process and is allowed to react accordingly. Another reflection image may be received and another distance of the object from an image generation unit and/or from an illumination source based on the reflection image may be determined and the other distance may be determined to be within or outside of the working range 450 as described in the context of FIG. 2. A result from the authentication process of the object is received 460 as described in the context of FIG. 2.

Authentication process may be performed based information received with the first reflection image or based on information received with the second reflection image. In an example, authentication process may be a face authentication process and authentication may only be performed if the distance is within the working range. Hence, face authentication process may be performed based on the second at least one reflection image. An object is allowed to access a resource based on the result from the authentication process being positive and the distance being in the working range of the authentication process 470 as described in the context of FIG. 2. Distance being in the working range may refer to any distance determined based on a reflection image. Distance being in the working range may be a first, second or any other distance as described above. Alternatively, the access of the object to a resource may be declined based on the authentication result and/or the distance being outside of the working range as described in the context of FIG. 2.

Example embodiment of method for authorizing an object may be carried out as described in the context of FIG. 3.

The present disclosure has been described in conjunction with preferred embodiments and examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place, i.e. each of the steps may be performed at part of a system and/or parts of a device.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, devices, the computer program element lined out above and vice versa. Advantageously, the benefits provided by any of the embodiments and examples equally apply to all other embodiments and examples and vice versa.

1. A computer-implemented method for authorizing an object, the method comprising:
a) receiving at least one reflection image showing at least a part of the object while the object is illuminated at least partially with electromagnetic radiation,
b) determining if the distance is within or outside of a working range of an authentication process based on the at least one reflection image, and
i) receiving a result from the authentication process of the object, and
allowing the object to access a resource based on the result from the authentication process being positive and the distance being in the working range of the authentication process
or
ii) declining the object to access a resource based on the distance being outside of the working range.

2. The method according to claim 1, wherein determining if the distance is within or outside of a working range of an authentication process comprises determining a distance based on the at least one reflection image and comparing the distance with a working range.

3. The method according to claim 1, further comprising determining a distance based on the at least one reflection image by using a model.

4. The method according to claim 1, wherein the authentication process is based on biometric information.

5. The method according to claim 1, further comprising determining a distance based on the at least one reflection by using one or more of depth from focus, depth from defocus, triangulation, depth-from-photon-ratio, determining a distance based on the distance between at least two spatial features based on a flood image and combinations thereof.

6. The method according to claim 1, wherein the object is provided with feedback based on determining if the distance is within or outside of a working range of an authentication process.

7. The method according to claim 1, wherein at least the steps a) to c) are repeated at least once in response to the distance being outside of the working range on the authentication process.

8. The method according to claim 1, wherein the at least one reflection image is received and/or generated in response to receiving an unlock request initiated by the object.

9. The method according to claim 1, wherein the method further comprises of and/or the authentication process comprises of at least one of:
receiving an image of at least a part of the object,
generating a low-level representation of the image,
determining a matching score of the low-level representation of the image and a low-level representation template, and
providing an authentication result associated with the matching score.

10. The method according to claim 1, wherein more than one distance is determined for more than one location in the reflection image and the object is allowed to access a resource based on the more than one distance being in the working range.

11. The method according to claim 1, wherein the distance is determined being in the working range of the authentication process based on determining if the distance is within or outside of a working range of an authentication process prior to providing the result of the authentication process or prior to generating a low-level representation of the reflection image.

12. The method according to claim 1, wherein the electromagnetic radiation comprises patterned electromagnetic radiation and/or is in the infrared range.

13. A method of using the distance as obtained by the method according to claim 1, the method comprising using the distance for allowing an object to access a resource and/or providing advice to an object associated with an authentication process.

14. A computer program element with instructions, which when executed on a processing device is configured to carry out the steps of the method of claim 1.

15. A device and/or a system for authorizing an object, the system comprising:
a) a receiving unit for receiving at least one reflection image showing at least a part of the object while the object is illuminated with electromagnetic radiation, and/or receiving a result from the authentication process of an object,
b) a processor configured for determining if the distance is within or outside of a working range of an authentication process based on the at least one reflection image, and
i) allowing the object to access a resource based on the result from the authentication process being positive and the distance being in the working range of the authentication process
or
ii) declining the object to access a resource based on the distance being outside of the working range.
